(19) United States
(12) Patent Application Publication
(10) Pub. No.: US 2026/0152056 A1
(43) Pub. Date: Jun. 4, 2026

(54) OFF-ROAD VEHICLE

(71) Applicant: KAWASAKI MOTORS, LTD., Akashi-shi (JP)

(72) Inventors: Jumpei TOKUDA, Akashi-shi (JP); Takahiro JYOUZAKI, Akashi-shi (JP)

(73) Assignee: KAWASAKI MOTORS, LTD., Akashi-shi (JP)

(21) Appl. No.: 19/393,620

(22) Filed: Nov. 19, 2025

(30) Foreign Application Priority Data
Dec. 4, 2024 (JP) 2024-211583

(51) Int. Cl. B60K 11/04; B60K 11/08

(52) U.S. Cl. CPC B60K 11/04; B60K 11/08

(57) ABSTRACT

An off-road vehicle includes: an internal combustion engine; a circulation passage in which cooling liquid that cools the internal combustion engine flows; a first radiator that is located behind an outside air introduction opening in a front space, is interposed in the circulation passage, and includes a first heat exchange core; and a second radiator that is located behind the first radiator in the front space, is interposed in the circulation passage, and includes a second heat exchange core. The first radiator is located such that the first heat exchange core overlaps the second heat exchange core from a front side.

### CROSS-REFERENCE TO RELATED APPLICATION

This application claims priority to and the benefit of Japanese Patent Application No. 2024-211583 filed on Dec. 4, 2024, the entire disclosure of which is incorporated herein by reference.

### BACKGROUND OF THE INVENTION

### Field of the Invention

The present disclosure relates to an off-road vehicle including a radiator.

### Description of the Related Art

U.S. Pat. No. 8,485,303 B2 discloses a utility vehicle including a radiator. The utility vehicle may also be called an off-road vehicle. This vehicle includes the radiator through which cooling water flows. The cooling water cools an internal combustion engine.

Increasing the size of the radiator to improve the cooling performance of the radiator leads to an increase in the size of the vehicle.

### SUMMARY OF THE INVENTION

An object of one aspect of the present disclosure is to improve the cooling performance of a radiator while preventing a vehicle from increasing in size.

An off-road vehicle according to one aspect of the present disclosure includes: a cabin in which an occupant seat is located; a front cover that covers a front space located in front of the cabin and includes at least one outside air introduction opening directed forward; an internal combustion engine; a circulation passage in which cooling liquid that cools the internal combustion engine flows; a first radiator that is located behind the outside air introduction opening in the front space, is interposed in the circulation passage, and includes a first heat exchange core; and a second radiator that is located behind the first radiator in the front space, is interposed in the circulation passage, and includes a second heat exchange core, wherein the first radiator is located such that the first heat exchange core overlaps the second heat exchange core from a front side.

### BRIEF DESCRIPTION OF THE DRAWINGS

FIG. 1 is a left side view of an off-road vehicle according to an embodiment.

FIG. 2 is the left side view of the off-road vehicle and shows an internal combustion engine cooling system of FIG. 1.

FIG. 3 is a left side view showing radiators of FIG. 2 and their vicinities.

FIG. 4 is a perspective view showing the radiators and a shroud of FIG. 3 as seen from a front-left side.

FIG. 5A is a front view showing a front portion of the off-road vehicle of FIG. 1 as seen from a front side.

FIG. 5B is a front view showing a state where a front upper cowl of FIG. 5A is detached.

### DETAILED DESCRIPTION

Hereinafter, an embodiment will be described with reference to the drawings. Unless otherwise specified, the directions mentioned in the following description are based on the directions of an off-road vehicle 1. A vehicle front-rear direction corresponds to a vehicle lengthwise direction, and a vehicle width direction corresponds to a vehicle left-right direction.

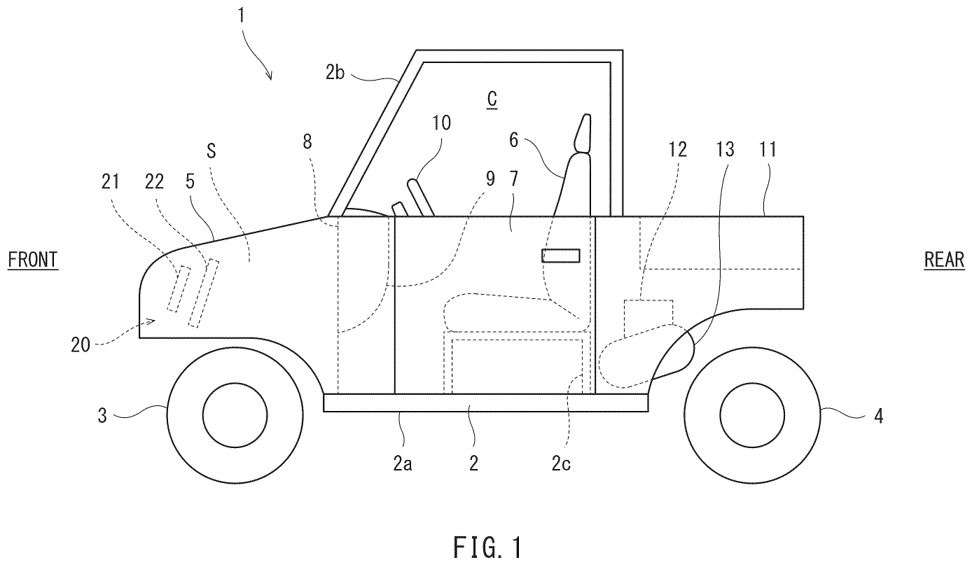

FIG. 1 is a left side view of the off-road vehicle 1 according to the embodiment. As shown in FIG. 1, the off-road vehicle 1 includes: a vehicle body frame 2; a pair of front wheels 3 that are left and right front wheels and support a front portion of the vehicle body frame 2; and a pair of rear wheels 4 that are left and right rear wheels and support a rear portion of the vehicle body frame 2. Tires for the front wheels 3 and the rear wheels 4 may be, for example, balloon tires for irregular ground traveling. The off-road vehicle 1 may also be called a utility vehicle.

The vehicle body frame 2 is a pipe frame including pipes connected to each other. The vehicle body frame 2 includes a floor frame 2a, a cabin frame 2b, a seat support frame 2c, and the like. The floor frame 2a supports an occupant seat 6 from below through the seat support frame 2c. The cabin frame 2b defines a cabin C in which the occupant seat 6 is located.

A front cover 5 supported by the vehicle body frame 2 is located in front of the cabin C. The front cover 5 covers, from above, a front space S located between the left and right front wheels 3. The front cover 5 includes an outside air introducing section 40 that opens the front space S forward and introduces outside air from the front side into the front space S. A first radiator 21 and a second radiator 22 of a below-described internal combustion engine cooling system 20 are located in the front space S. The first radiator 21 is located behind the outside air introducing section 40. The second radiator 22 is located behind the first radiator 21.

Side doors 7 are located at both lateral sides of the cabin C. Each side door 7 opens and closes an entrance through which an occupant gets in and out of the cabin C. The front space S and the cabin C are separated from each other by a dash panel 8. A dashboard 9 is located behind the dash panel 8 and in front of the occupant seat 6. The dashboard 9 faces the occupant seat 6 from the front side. The dashboard 9 includes meters. A steering wheel 10 opposed to the occupant seat 6 is located at the dashboard 9. An electric component and the like are accommodated in a space between the dash panel 8 and the dashboard 9.

A cargo bed 11 is located behind the cabin frame 2b. The cargo bed 11 defines a recessed loading space that is open upward. An internal combustion engine 12 supported by the vehicle body frame 2 is located behind the occupant seat 6 as a prime mover. In the side view, at least a part of the internal combustion engine 12 is located vertically under the cargo bed 11.

A continuously variable transmission 13 is located adjacent to the internal combustion engine 12. The continuously variable transmission 13 changes a rotational speed of driving power output from the internal combustion engine 12. The driving power output from the continuously variable transmission 13 is transmitted to the front wheels 3 or the rear wheels 4 or to the front wheels 3 and the rear wheels 4. The internal combustion engine 12 is a prime mover for traveling. However, a combination of the internal combustion engine and an electric motor may be the prime mover, or only the electric motor may be the prime mover.

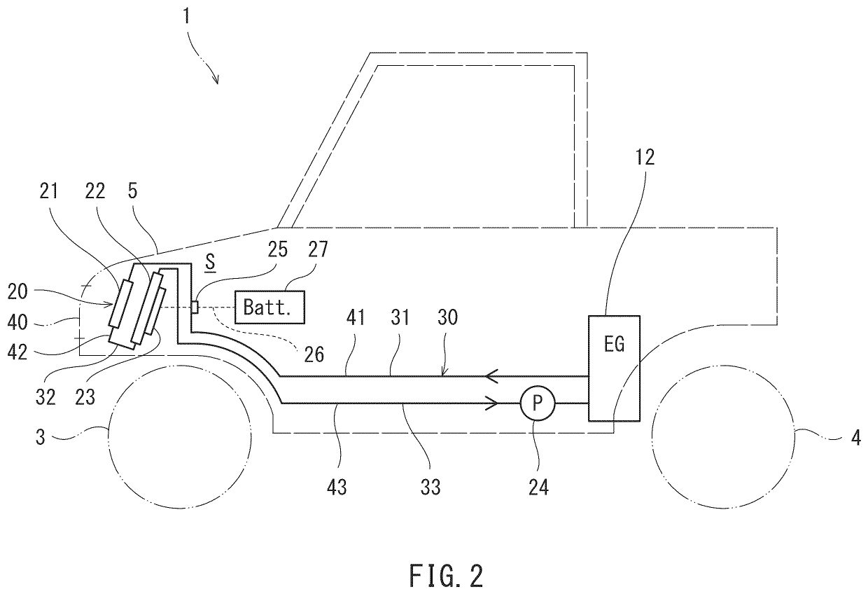

FIG. 2 is the left side view of the off-road vehicle 1 and shows the internal combustion engine cooling system 20 of FIG. 1. As shown in FIG. 2, the off-road vehicle 1 includes the internal combustion engine cooling system 20. The internal combustion engine cooling system 20 includes a circulation passage 30, the first radiator 21, the second radiator 22, a radiator fan 23, a cooling liquid pump 24, a thermo switch 25, and a power supply line 26.

The circulation passage 30 is a closed loop passage in which cooling liquid flows. The cooling liquid cools the internal combustion engine 12. The first radiator 21 and the second radiator 22 which are located in the front space S are interposed in the circulation passage 30. The circulation passage 30 includes a first cooling liquid passage 31, a second cooling liquid passage 32, and a third cooling liquid passage 33. The first cooling liquid passage 31 connects an outlet of a cooling passage of the internal combustion engine 12 to the first radiator 21. The second cooling liquid passage 32 connects the first radiator 21 to the second radiator 22. The third cooling liquid passage 33 connects the second radiator 22 to an inlet of the cooling passage of the internal combustion engine 12. The first cooling liquid passage 31 is defined by a first cooling liquid tube 41. The second cooling liquid passage 32 is defined by a second cooling liquid tube 42. The third cooling liquid passage 33 is defined by a third cooling liquid tube 43.

The cooling liquid pump 24 is interposed in the circulation passage 30. For example, the cooling liquid pump 24 is located in the third cooling liquid passage 33. The cooling liquid pump 24 sends the cooling liquid such that the cooling liquid flows through the internal combustion engine 12, the first cooling liquid passage 31, the first radiator 21, the second cooling liquid passage 32, the second radiator 22, the third cooling liquid passage 33, and the internal combustion engine 12 in this order. To be specific, since the first radiator 21 and the second radiator 22 are located in series in the circulation passage 30, the cooling liquid flowing in the circulation passage 30 is cooled stepwise by the first radiator 21 and the second radiator 22. The first radiator 21 is located upstream of the second radiator 22 in the circulation passage 30. Thus, a temperature difference between the air and the cooling liquid in the first radiator 21 increases, and therefore, the cooling liquid is effectively cooled. In addition, the cooling liquid is further cooled by the second radiator 22.

The radiator fan 23 is attached to the second radiator 22 while being located adjacent to a rear side of the second radiator 22. When the radiator fan 23 is driven, air flow from the front side to the rear side of the second radiator 22 is generated. The thermo switch 25 that operates in accordance with the temperature of the cooling liquid flowing in the circulation passage 30 is located in the circulation passage 30. For example, the thermo switch 25 is located in the first cooling liquid passage 31. The thermo switch 25 is interposed in the power supply line 26 that supplies electric power of a battery 27 to the radiator fan 23.

When the temperature of the cooling liquid flowing in the first cooling liquid passage 31 exceeds a predetermined threshold, the thermo switch 25 becomes an ON state. When the temperature of the cooling liquid flowing in the first cooling liquid passage 31 becomes the threshold or less, the thermo switch 25 becomes an OFF state. Therefore, when the temperature of the cooling liquid flowing in the circulation passage 30 becomes high, the thermo switch 25 becomes the ON state, and the radiator fan 23 operates. On the other hand, when the temperature of the cooling liquid flowing in the circulation passage 30 becomes low, the thermo switch 25 becomes the OFF state, and the radiator fan 23 stops.

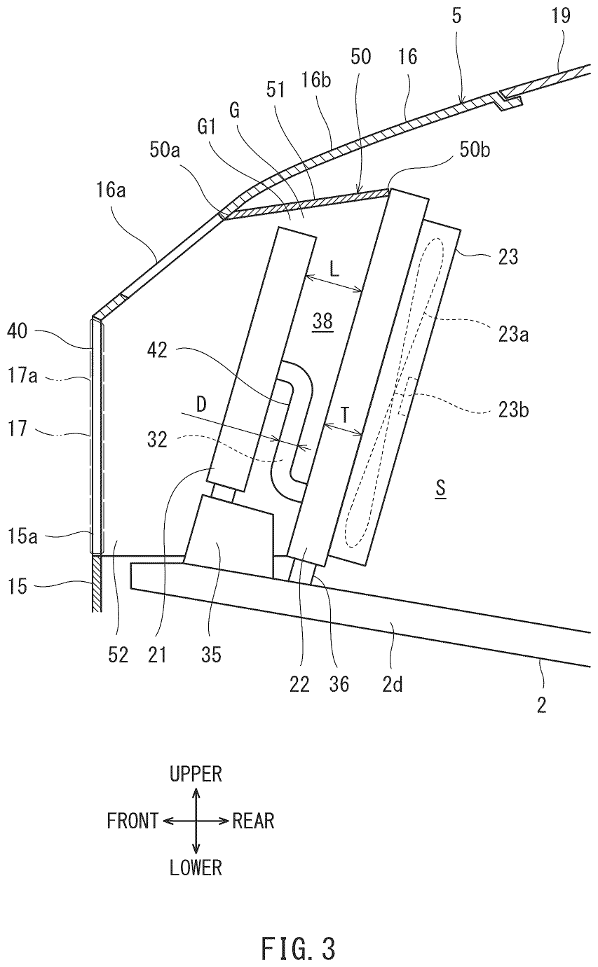

FIG. 3 is a left side view showing the radiators 21 and 22 of FIG. 2 and their vicinities. As shown in FIG. 3, the first radiator 21 is supported by a front frame 2d of the vehicle body frame 2 through a bracket 35. The second radiator 22 is supported by the front frame 2d through a bracket 36. The first radiator 21 is located so as to overlap the second radiator 22 from the front side. The radiator fan 23 is attached to the second radiator 22 while being located adjacent to the rear side of the second radiator 22.

The radiator fan 23 includes a fan vane 23a and a fan motor 23b that drives the fan vane 23a. The radiator fan 23 is located so as to send air rearward. The flow of the air that passes through the second radiator 2 from the front side to the rear side is generated by the driving of the radiator fan 23. Since the first radiator 21 is located in front of the second radiator 22, the air may pass through both of the first radiator 21 and the second radiator 22 by the driving of the radiator fan 23.

There is a cavity 38 between the first radiator 21 and the second radiator 22. The cavity 38 is an air space where no parts exist. To be specific, the first radiator 21 is directly opposed to the second radiator 22 without any interposed member. In a thickness direction of the second radiator 22, a size L of the cavity 38 between the first radiator 21 and the second radiator 22 is larger than a thickness T of the second radiator 22. In the thickness direction of the second radiator 22, the size L of the cavity 38 may be larger than a thickness of a below-described second heat exchange core 22a or may be larger than a thickness of each of a pair of second tanks 22b described below. When the radiator fan 23 drives, the air in a wide range passes through the second radiator 22 by utilizing the cavity 38 between the first radiator 21 and the second radiator 22.

The first radiator 21 is connected to the second radiator 22 through the second cooling liquid tube 42. The second cooling liquid tube 42 is connected to a back surface of the first radiator 21 from the rear side of the first radiator 21. Specifically, the second cooling liquid tube 42 is connected to a rear portion of one of a pair of first tanks 21b, described below, of the first radiator 21. In the thickness direction of the second radiator 22, the cavity 38 between the first radiator 21 and the second radiator 22 is larger than an outer diameter D of the second cooling liquid tube 42. At least a part of the second cooling liquid tube 42 is located in the cavity 38. The second cooling liquid tube 42 may include a portion that extends along the back surface of the first radiator 21 in the cavity 38.

A height dimension of the first radiator 21 is smaller than a height dimension of the second radiator 22. An upper end of the first radiator 21 is lower than an upper end of the second radiator 22. A lower end of the first radiator 21 is higher than a lower end of the second radiator 22.

The first radiator 21 is inclined rearward relative to a vertical direction such that the upper end thereof is located behind the lower end thereof. The second radiator 22 is also inclined rearward relative to the vertical direction such that the upper end thereof is located behind the lower end thereof. For example, when viewed in the vehicle width direction, the first radiator 21 is located in parallel with the second radiator 22. To be specific, the first radiator 21 and the second radiator 22 extend diagonally upward and rearward. Each of an inclination angle of the first radiator 21 relative to the vertical direction and an inclination angle of the second radiator 22 relative to the vertical direction is less than 45 degrees, preferably 30 degrees.

One of the first radiator 21 and the second radiator 22 may extend diagonally upward and rearward, and the other of the first radiator 21 and the second radiator 22 may extend upward at such an angle as to be closer to the vertical direction than the above one of the radiators 21 and 22.

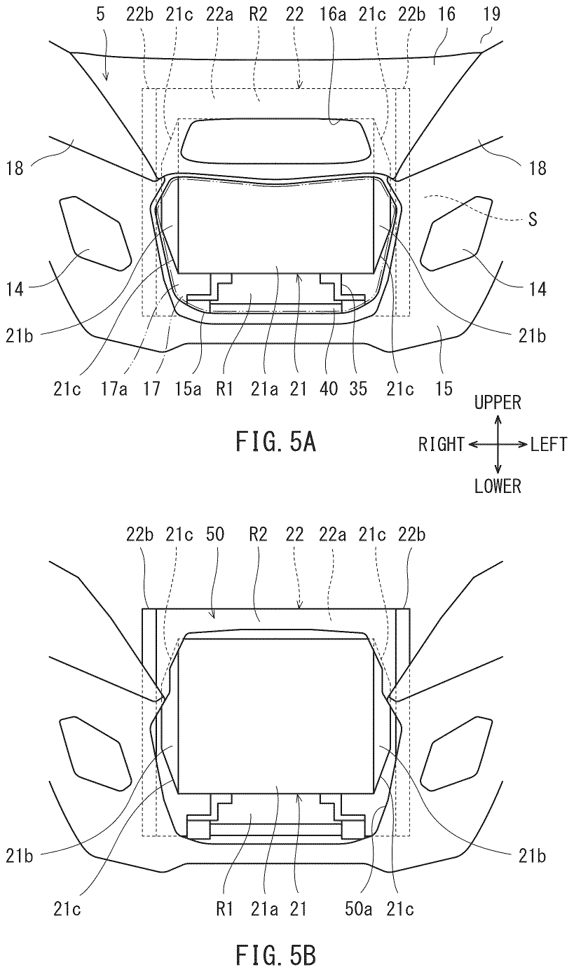

As shown in FIG. 5A, the front cover 5 includes a front lower cowl 15, a front upper cowl 16, a front grill 17, a pair of front side cowls 18, and a front hood 19. A specific configuration of the front cover 5 is not limited to the above-described configuration, and various configurations may be adopted.

The front lower cowl 15 covers the front space S from the front side. Head lights 14 are located at the front lower cowl 15. The front lower cowl 15 includes a front grill opening 15a. The front upper cowl 16 is adjacently located at the upper side of the front lower cowl 15. The front upper cowl 16 covers a front portion of the front space S from the upper side. The front upper cowl 16 includes an outside air introduction opening 16a.

The front grill 17 is located at the front grill opening 15a. The front grill 17 has, for example, a lattice shape and includes outside air introduction openings 17a. Another front grill may be located at the outside air introduction opening 16a of the front upper cowl 16. The front side cowls 18 are located at the upper side of the front lower cowl 15 and at both left and right sides of the front upper cowl 16. The front hood 19 is located behind the front upper cowl 16 and partially overlaps the front upper cowl 16 from the upper side. When the front hood 19 is opened, the front space S is opened upward.

Referring back to FIG. 3, the outside air introduction openings 17a of the front grill 17 and the outside air introduction opening 16a of the front upper cowl 16 constitute the outside air introducing section 40 of the front cover 5. The outside air introducing section 40 is opposed to the first radiator 21 and the second radiator 22 in a horizontal direction. The front cover 5 includes a slope portion 16b that is located vertically above the first radiator 21 and the second radiator 22 and extends forward and downward. Specifically, the front upper cowl 16 includes the slope portion 16b. A shroud 50 is located in the front space S.

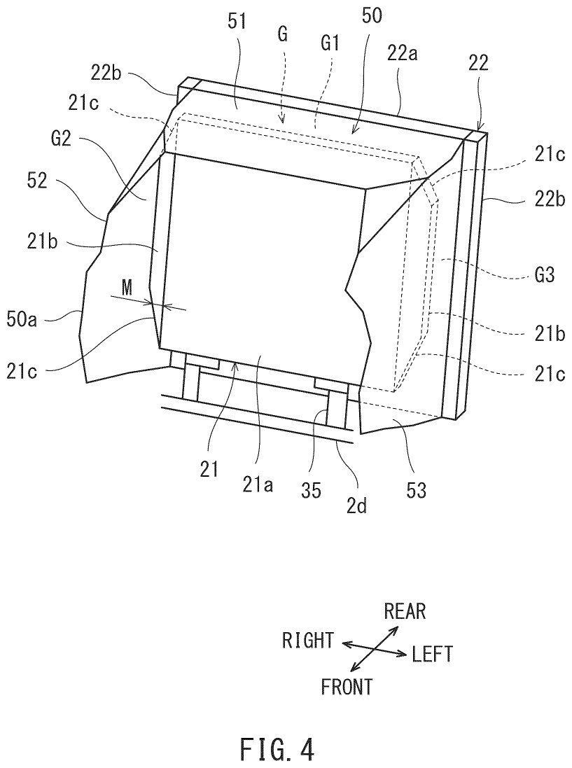

FIG. 4 is a perspective view showing the radiators 21 and 22 and the shroud 50 of FIG. 3 as seen from a front-left side. As shown in FIGS. 3 and 4, the shroud 50 guides the air from the outside air introducing section 40 of the front cover 5 to the first radiator 21 and the second radiator 22. The shroud 50 surrounds the first radiator 21 in a direction orthogonal to the vehicle front-rear direction. The shroud 50 includes an upper wall portion 51, a right wall portion 52, and a left wall portion 53. The upper wall portion 51 covers the first radiator 21 from the upper side. The right wall portion 52 covers the first radiator 21 from the right side. The left wall portion 53 covers the first radiator 21 from the left side. An air guide space surrounded by the shroud 50 is open downward. To be specific, the shroud 50 does not include a lower wall portion.

A front end 50a of the shroud 50 includes front ends of the upper wall portion 51, the right wall portion 52, and the left wall portion 53. The front end 50a of the shroud 50 is located so as to surround the entire outside air introducing section 40. The front end 50a of the shroud 50 is in contact with the front cover 5 around the outside air introducing section 40. To be specific, the front end 50a of the shroud 50 is in contact with the front cover 5 around the entire outside air introduction opening 16a of the front upper cowl 16 and the entire outside air introduction openings 17a of the front grill 17. Therefore, the shroud 50 guides the air, which has flowed into the front space S through the outside air introduction openings 16a and 17a, collectively toward the radiators 21 and 22.

The air which has flowed into the front space S through the outside air introducing section 40 of the front cover 5 is guided by the shroud 50 and passes through the first radiator 21 and the second radiator 22. To be specific, the shroud 50 promotes the passing of the air through the first radiator 21 and the second radiator 22, and this improves the cooling performance of the first radiator 21 and the second radiator 22.

A rear end 50b of the shroud 50 includes rear ends of the upper wall portion 51, the right wall portion 52, and the left wall portion 53. The rear end 50b of the shroud 50 is in contact with an outer edge portion of the second radiator 22. There is a gap G between the shroud 50 and the first radiator 21 in a direction orthogonal to the vehicle front-rear direction. Specifically, there are a gap G1 between the upper wall portion 51 and the first radiator 21, a gap G2 between the right wall portion 52 and the first radiator 21, and a gap G3 between the left wall portion 53 and the first radiator 21.

The gap G1 is located above the first radiator 21. The upper wall portion 51 opposed to the first radiator 21 from a vertically upper side extends diagonally forward and downward. However, since the upper end of the first radiator 21 is lower than the upper end of the second radiator 22, there is the gap G1 between the upper wall portion 51 and the first radiator 21. The gaps G2 and G3 are gaps located outside the first radiator 21 in the vehicle width direction.

The air which has flowed into the front space S through the outside air introducing section 40 of the front cover 5 can pass through the first radiator 21 and then reach the second radiator 22 and can also pass through the gap G without passing through the first radiator 21 and then reach the second radiator 22. To be specific, the air which has flowed into the front space S through the outside air introducing section 40 of the front cover 5 can pass through the gap G1 located above the first radiator 21 and then reach the below-described second heat exchange core 22a of the second radiator 22 and can also pass through the gaps G2 and G3 located at both lateral sides of the first radiator 21 and then reach the second heat exchange core 22a of the second radiator 22.

The first radiator 21 includes: a first heat exchange core 21a; and the pair of first tanks 21b located at both left and right sides of the first heat exchange core 21a. Internal spaces of the first tanks 21b communicate with a cooling medium passage of the first heat exchange core 21a. One of the first tanks 21b is connected to the above-described first cooling liquid tube 41, and the other of the first tanks 21b is connected to the above-described second cooling liquid tube 42. The first cooling liquid tube 41 may be connected to a rear surface of the first tank 21b or may be connected to a side surface of the first tank 21b. When the air passes through the first heat exchange core 21a in the vehicle front-rear direction, the cooling liquid flowing through the first heat exchange core 21a performs heat exchange with the air to be cooled. Each first tank 21b includes tapered portions 21c located at end portions in a longitudinal direction of the first tank 21b. In the first radiator 21, a projection amount M of each tapered portion 21c from the first heat exchange core 21a gradually decreases as the tapered portion 21c extends toward the outside of the first tank 21b in the longitudinal direction.

The second radiator 22 includes the second heat exchange core 22a and the pair of second tanks 22b located at both left and right sides of the second heat exchange core 22a. Internal spaces of the second tanks 22b communicate with a cooling medium passage of the second heat exchange core 22a. One of the second tanks 22b is connected to the above-described second cooling liquid tube 42, and the other of the second tanks 22b is connected to the above-described third cooling liquid tube 43. The second cooling liquid tube 42 may be connected to a front surface of the second tank 22b of the second radiator 22 or may be connected to a side surface of the second tank 22b. The third cooling liquid tube 43 may be connected to a rear surface of the second tank 22b or may be connected to a side surface of the second tank 22b. When the air passes through the second heat exchange core 22a in the vehicle front-rear direction, the cooling liquid flowing through the second heat exchange core 22a performs heat exchange with the air to be cooled.

FIG. 5A is a front view showing a front portion of the off-road vehicle 1 of FIG. 1 as seen from the front side. FIG. 5B is a front view showing a state where the front upper cowl 16 of FIG. 5A is detached. As shown in FIGS. 5A and 5B, in the front view, the first heat exchange core 21a of the first radiator 21 overlaps the second heat exchange core 22a of the second radiator 22 from the front side. In the front view, the entire first heat exchange core 21a may overlap the second heat exchange core 22a from the front side, or at least a part of the first heat exchange core 21a may overlap the second heat exchange core 22a from the front side. In the front view, the first radiator 21 may be smaller than the second radiator 22. To be specific, in the front view, the combination of the first heat exchange core 21a and the first tanks 21b may be smaller than the combination of the second heat exchange core 22a and the second tanks 22b. In the front view, the first heat exchange core 21a may be smaller than the second heat exchange core 22a.

The upper end of the first radiator 21 is lower than an upper end of the second heat exchange core 22a of the second radiator 22, and the lower end of the first radiator 21 is higher than a lower end of the second heat exchange core 22a of the second radiator 22. Moreover, a right end of the first radiator 21 is located at an inside of a right end of the second heat exchange core 22a of the second radiator 22 in the left-right direction, i.e., a left side of the right end of the second heat exchange core 22a, and a left end of the first radiator 21 is located at an inside of a left end of the second heat exchange core 22a of the second radiator 22 in the left-right direction, i.e., a right side of the left end of the second heat exchange core 22a.

In the front view, an outer peripheral portion of the second heat exchange core 22a protrudes from the first radiator 21. To be specific, in the front view, the second heat exchange core 22a includes a portion that is not obscured by the first radiator 21. Moreover, each first tank 21b of the first radiator 21 includes the tapered portions 21c. Therefore, in the front view, the portion of the second heat exchange core 22a which is not obscured by the first radiator 21 increases without changing the size of the first heat exchange core 21a.

The air which has flowed from the front side into the front space S through the outside air introducing section 40 may pass through the first heat exchange core 21a of the first radiator 21 and then pass through the second heat exchange core 22a of the second radiator 22 and may also pass through the second heat exchange core 22a of the second radiator 22 without passing through the first heat exchange core 21a of the first radiator 21. To be specific, in addition to the air which has been increased in temperature by passing through the first heat exchange core 21a of the first radiator 21, cold air which has passed through the outside of the first radiator 21 easily reaches the second heat exchange core 22a of the second radiator 22. Therefore, the cooling performance of the second radiator 22 improves.

The second heat exchange core 22a of the second radiator 22 includes: a lower region R1 protruding downward from the first radiator 21 in the front view; and an upper region R2 protruding upward from the first radiator 21 in the front view. In the front view, the lower region R1 of the second heat exchange core 22a is exposed through the outside air introduction openings 17a of the front grill 17. Thus, the air which has flowed through the outside air introduction openings 17a of the front grill 17 and then flowed rearward through a space located under the first radiator 21 easily passes through the lower region R1 of the second heat exchange core 22a.

In the front view, the upper region R2 of the second heat exchange core 22a is located above the outside air introduction opening 16a of the front upper cowl 16. To be specific, the upper region R2 of the second heat exchange core 22a is located above all the outside air introduction openings 17a and the outside air introduction opening 16a, i.e., the outside air introducing section 40.

Since the upper wall portion 51 of the shroud 50 extends rearward and upward, the air which has flowed into the front space S through the outside air introduction opening 16a may flow rearward and upward along a lower surface of the upper wall portion 51 of the shroud 50. Moreover, the first radiator 21 is inclined rearward. Therefore, when the air which has flowed through the outside air introduction opening 16a flows along a front surface of the first radiator 21, the air tends to flow upward. Therefore, part of the air which has flowed into the front space S through the outside air introduction opening 16a passes through a space located above the first radiator 21 and then passes through the lower region R1 of the second heat exchange core 22a.

According to the above-described configuration, since the air performs heat exchange with the two radiators 21 and 22, the cooling performance of the internal combustion engine cooling system 20 can be improved without increasing the areas of the radiators 21 and 22. Moreover, since the two radiators 21 and 22 are located so as to overlap each other, a region occupied by the combination of the two radiators 21 and 22 can be reduced. Therefore, while preventing the off-road vehicle 1 from increasing in size, the cooling performance of the radiators 21 and 22 can be improved.

The foregoing has described the embodiment as an example of the technology disclosed in the present application. However, the technology in the present disclosure is not limited to this and is applicable to embodiments in which modifications, replacements, additions, omissions, and the like have been suitably made. Moreover, a new embodiment may be prepared by combining the components described in the above embodiment. For example, some of components or methods in one embodiment may be applied to another embodiment. Some components in an embodiment may be separated from the other components in the embodiment and arbitrarily extracted. Furthermore, the components shown in the attached drawings and the detailed explanations include not only components essential to solve the problems but also components for exemplifying the above technology and not essential to solve the problems.

### Aspects

The above embodiment is a specific example of the following aspects.

### First Aspect

An off-road vehicle including:
a cabin in which an occupant seat is located;
a front cover that covers a front space located in front of the cabin and includes at least one outside air introduction opening directed forward;
an internal combustion engine;
a circulation passage in which cooling liquid that cools the internal combustion engine flows;
a first radiator that is located behind the outside air introduction opening in the front space, is interposed in the circulation passage, and includes a first heat exchange core; and
a second radiator that is located behind the first radiator in the front space, is interposed in the circulation passage, and includes a second heat exchange core, wherein
the first radiator is located such that the first heat exchange core overlaps the second heat exchange core from a front side.

According to this configuration, since the air performs heat exchange with the two radiators, the cooling performance can be improved without increasing the areas of the radiators. Moreover, since the two radiators are located so as to overlap each other, a region occupied by the combination of the two radiators can be reduced. Therefore, while preventing the vehicle from increasing in size, the cooling performance of the radiators can be improved.

### Second Aspect

The off-road vehicle according to the first aspect, wherein the first radiator is located upstream of the second radiator in the circulation passage.

According to this configuration, the two radiators are located in series in the circulation passage. Therefore, the piping of the circulation passage can be simplified, and the cooling liquid flowing in the circulation passage can be cooled stepwise. Moreover, the first radiator is located in front of the second radiator and upstream of the second radiator in the circulation passage. Therefore, the cooling liquid can be effectively cooled by the first radiator due to a large temperature difference between the air and the cooling liquid, and the cooling liquid can be further cooled by the second radiator.

### Third Aspect

The off-road vehicle according to the first or second aspect, wherein in a front view, the first radiator is smaller than the second radiator.

According to this configuration, in addition to the air which has been increased in temperature by passing through the first radiator, the air which does not pass through the first radiator easily reaches the second radiator. Therefore, the cooling performance of the second radiator can be improved.

### Fourth Aspect

The off-road vehicle according to the third aspect, wherein the first radiator is located such that an upper end of the first radiator is lower than an upper end of the second heat exchange core, and a lower end of the first radiator is higher than a lower end of the second heat exchange core.

According to this configuration, the air which has passed through the upper and lower sides of the first radiator can reach the second heat exchange core of the second radiator. Thus, the cooling performance of the second radiator can be improved.

### Fifth Aspect

The off-road vehicle according to any one of the first to fourth aspects, further including a radiator fan located behind the second radiator, wherein
in a thickness direction of the second radiator, a cavity between the first radiator and the second radiator is larger than a thickness of the second radiator.

According to this configuration, when the radiator fan drives, the air in a wide range can pass through the second radiator by utilizing the cavity between the first radiator and the second radiator. Thus, the cooling performance of the second radiator can be improved.

### Sixth Aspect

The off-road vehicle according to any one of the first to fifth aspects, wherein:
the circulation passage includes a cooling liquid tube that connects the first radiator to the second radiator; and
in a thickness direction of the second radiator, a cavity between the first radiator and the second radiator is larger than an outer diameter of the cooling liquid tube.

According to this configuration, the cooling liquid tube can be connected to the back surface of the first radiator. Thus, the degree of freedom of the arrangement of the cooling liquid tube can be improved.

### Seventh Aspect

The off-road vehicle according to any one of the first to sixth aspects, wherein:
the front cover includes a slope portion that is located vertically above the first radiator and the second radiator and extends forward and downward; and
the first radiator is located such that an upper end of the first radiator is lower than an upper end of the second radiator.

According to this configuration, the first radiator and the second radiator can be located close to the slope portion of the front cover in the vertical direction. Therefore, the part layout efficiency in the front space can be improved.

### Eighth Aspect

The off-road vehicle according to any one of the first to seventh aspects, wherein at least one of the first radiator or the second radiator is inclined rearward relative to a vertical direction such that an upper end thereof is located behind a lower end thereof.

According to this configuration, at least one of the first radiator or the second radiator is made compact in the vertical direction. Therefore, the part layout efficiency in the front space can be improved.

### Ninth Aspect

The off-road vehicle according to the eighth aspect, wherein:
the first radiator is inclined rearward relative to the vertical direction such that the upper end of the first radiator is located behind the lower end of the first radiator;
the second heat exchange core includes
   a lower region protruding downward from the first radiator in a front view and
   an upper region protruding upward from the first radiator in the front view;
the lower region of the second heat exchange core is exposed through the at least one outside air introduction opening in the front view; and
the upper region of the second heat exchange core is located above the entirety of the at least one outside air introduction opening in the front view.

According to this configuration, the lower region of the second heat exchange core is exposed through the outside air introduction opening in the front view. Therefore, the air which has flowed from the outside air introduction opening rearward under the first radiator easily passes through the lower region of the second heat exchange core. Moreover, the first radiator is inclined rearward. Therefore, when the air which has flowed from the outside air introduction opening flows along the front surface of the first radiator, the air tends to flow upward, not downward. Thus, the air easily reaches the upper region of the second heat exchange core. Therefore, the cooling performance of the second radiator can be improved while improving the cooling performance of the first radiator.

### Tenth Aspect

The off-road vehicle according to any one of the first to ninth aspects, further including a shroud that is located in the front space and guides outside air from the at least one outside air introduction opening to the second radiator, wherein
the shroud surrounds the first radiator in a direction orthogonal to a vehicle front-rear direction.

According to this configuration, the passing of the air, which has flowed into the front space through the outside air introduction opening of the front cover, through the first radiator and the second radiator can be promoted. Therefore, the cooling performance of the radiators can be improved.

### Eleventh Aspect

The off-road vehicle according to the tenth aspect, wherein there is a gap between the shroud and the first radiator in the direction orthogonal to the vehicle front-rear direction.

According to this configuration, the air which has flowed into the front space through the outside air introduction opening of the front cover can pass through the first radiator and then reach the second radiator and can also reach the second radiator without passing through the first radiator. Therefore, the cooling performance of the first radiator and the cooling performance of the second radiator can be satisfactorily balanced.

### Twelfth Aspect

The off-road vehicle according to the eleventh aspect, wherein the gap between the shroud and the first radiator includes a gap located outside the first radiator in a vehicle width direction.

According to this configuration, the air which has flowed into the front space through the outside air introduction opening of the front cover can pass through the gap located at a lateral side of the first radiator and then reach the second radiator. Therefore, the cooling performance of the second radiator can be improved by utilizing a portion of the second radiator which is located at the outside in the vehicle width direction.

### Thirteenth Aspect

The off-road vehicle according to the eleventh or twelfth aspect, wherein the gap between the shroud and the first radiator includes a gap located above the first radiator.

According to this configuration, the air which has flowed into the front space through the outside air introduction opening of the front cover can reach the second radiator through the gap located above the first radiator. Therefore, the cooling performance of the second radiator can be improved by using an upper portion of the second radiator.

### Fourteenth Aspect

The off-road vehicle according to the tenth or eleventh aspect, wherein:
the at least one outside air introduction opening includes outside air introduction openings; and
the shroud is located such that a front end of the shroud surrounds all the outside air introduction openings in a front view.

According to this configuration, the air which has flowed into the front space through the outside air introduction openings can be collectively guided to the radiators.

### Fifteenth Aspect

The off-road vehicle according to the fourteenth aspect, wherein the front end of the shroud is in contact with the front cover around all the outside air introduction openings.

According to this configuration, the air which has flowed into the front space through the outside air introduction openings can be stably guided to the air guide space of the shroud.

### Sixteenth Aspect

The off-road vehicle according to any one of the tenth to fifteenth aspects, wherein:
the shroud includes
   an upper wall portion covering the first radiator from an upper side,
   a right wall portion covering the first radiator from a right side, and
   a left wall portion covering the first radiator from a left side; and
an air guide space surrounded by the shroud is open downward.

According to this configuration, a structure that supports the first radiator from below can be easily located without interfering with the shroud.

What is claimed is:

1. An off-road vehicle comprising:
a cabin in which an occupant seat is located;
a front cover that covers a front space located in front of the cabin and includes at least one outside air introduction opening directed forward;
an internal combustion engine;
a circulation passage in which cooling liquid that cools the internal combustion engine flows;
a first radiator that is located behind the outside air introduction opening in the front space, is interposed in the circulation passage, and includes a first heat exchange core; and
a second radiator that is located behind the first radiator in the front space, is interposed in the circulation passage, and includes a second heat exchange core, wherein
the first radiator is located such that the first heat exchange core overlaps the second heat exchange core from a front side.

2. The off-road vehicle according to claim 1, wherein the first radiator is located upstream of the second radiator in the circulation passage.

3. The off-road vehicle according to claim 1, wherein in a front view, the first radiator is smaller than the second radiator.

4. The off-road vehicle according to claim 3, wherein the first radiator is located such that an upper end of the first radiator is lower than an upper end of the second heat exchange core, and a lower end of the first radiator is higher than a lower end of the second heat exchange core.

5. The off-road vehicle according to claim 1, further comprising a radiator fan located behind the second radiator, wherein
in a thickness direction of the second radiator, a cavity between the first radiator and the second radiator is larger than a thickness of the second radiator.

6. The off-road vehicle according to claim 1, wherein:
the circulation passage includes a cooling liquid tube that connects the first radiator to the second radiator; and
in a thickness direction of the second radiator, a cavity between the first radiator and the second radiator is larger than an outer diameter of the cooling liquid tube.

7. The off-road vehicle according to claim 1, wherein:
the front cover includes a slope portion that is located vertically above the first radiator and the second radiator and extends forward and downward; and
the first radiator is located such that an upper end of the first radiator is lower than an upper end of the second radiator.

8. The off-road vehicle according to claim 1, wherein at least one of the first radiator or the second radiator is inclined rearward relative to a vertical direction such that an upper end thereof is located behind a lower end thereof.

9. The off-road vehicle according to claim 8, wherein:
the first radiator is inclined rearward relative to the vertical direction such that the upper end of the first radiator is located behind the lower end of the first radiator;
the second heat exchange core includes
a lower region protruding downward from the first radiator in a front view and
an upper region protruding upward from the first radiator in the front view;
the lower region of the second heat exchange core is exposed through the at least one outside air introduction opening in the front view; and
the upper region of the second heat exchange core is located above the entirety of the at least one outside air introduction opening in the front view.

10. The off-road vehicle according to claim 1, further comprising a shroud that is located in the front space and guides outside air from the at least one outside air introduction opening to the second radiator, wherein
the shroud surrounds the first radiator in a direction orthogonal to a vehicle front-rear direction.

11. The off-road vehicle according to claim 10, wherein there is a gap between the shroud and the first radiator in the direction orthogonal to the vehicle front-rear direction.

12. The off-road vehicle according to claim 11, wherein the gap between the shroud and the first radiator includes a gap located outside the first radiator in a vehicle width direction.

13. The off-road vehicle according to claim 11, wherein the gap between the shroud and the first radiator includes a gap located above the first radiator.

14. The off-road vehicle according to claim 10, wherein:
the at least one outside air introduction opening comprises outside air introduction openings; and
the shroud is located such that a front end of the shroud surrounds all the outside air introduction openings in a front view.

15. The off-road vehicle according to claim 14, wherein the front end of the shroud is in contact with the front cover around all the outside air introduction openings.

16. The off-road vehicle according to claim 10, wherein:
the shroud includes
an upper wall portion covering the first radiator from an upper side,
a right wall portion covering the first radiator from a right side, and
a left wall portion covering the first radiator from a left side; and
an air guide space surrounded by the shroud is open downward.
